(19) United States
(12) Patent Application Publication
(10) Pub. No.: US 2016/0180512 A1
(43) Pub. Date: Jun. 23, 2016

(54) DEPTH-RANKED CONTENT VIEWER

(71) Applicant: NBCUniversal Media, LLC, New York, NY (US)

(72) Inventors: Jeffrey Myers, Fairfield, CT (US); Matt DuLeone, Emerson, NJ (US); Samuel J. Harrell, Carleton, MI (US)

(21) Appl. No.: 14/579,814

(22) Filed: Dec. 22, 2014

(51) Int. Cl. G06T 7/00; G06T 1/00; G06T 15/00; G06F 3/0481; G06T 11/00

(52) U.S. Cl. CPC G06T 7/004; G06F 3/04815; G06T 11/00; G06T 7/0051; G06T 15/005; G06T 1/00; G06F 2203/04806

(57) ABSTRACT

Passive content presentation systems and methods are provided herein. The provided systems and methods provide a depth-ranked presentation of content, enabling provision of a multitude of content in a manner that is easy to consume by passive consumption.

### BACKGROUND

The current specification relates generally to content provision. Specifically, this specification relates to providing content in a meaningful way to facilitate passive content consumption.

As the number of available content playback devices increases and the number of content sources increase, content provision has increased exponentially. Users have access to content from cellular telephones, tablet computers, personal computers, televisions, etc. Further, the content may be sourced from a multitude of sources.

A range of techniques have been developed to provide content to consumers for passive consumption (consumption that is not facilitated by actively seeking out the content). For example, social networking sites provide content to consumers based upon content posted by linked acquaintances. These content consumers may leave an active feed of the social networking site open, enabling the consumers to select content for consumption as the site offers it. Additionally, when dealing with video, some video content provision sites provide video content playlists based upon input of the curator of the content and/or site-wide recommendation rules

Such techniques, while effective, tend to be quite simple, and allow for somewhat limited in terms of the options for the selection and provision of passive content. That is, many such systems may be designed to provision content based upon relatively few factors.

As the amount of content available to a consumer increases, there is a need for enhanced content provision, in a manner that enables more effective passive content consumption, displaying the content in an informative manner, using a multitude of factors. Such techniques may spark consumer interest, enabling increased effectiveness of content offerings.

### BRIEF DESCRIPTION

The present specification provides systems and methods for recommending digital content for passive consumption. As content is received, it is ranked based upon any number of factors. Based upon the ranking, the content is provided, via a viewer, to a passive consumer of content. The viewer may present a multitude of content using a three dimensional coordinate system (e.g., X, Y, and Z rectangular coordinates; r, θ, z cylindrical coordinates; r, θ, φ spherical coordinates, etc.). Further, a variety of shapes, positions, colors, and/or other variables may be used to organize and/or present the content, providing a rich representation of the content.

### DRAWINGS

These and other features, aspects, and advantages of the present invention will become better understood when the following detailed description is read with reference to the accompanying drawings in which like characters represent like parts throughout the drawings, wherein:

FIG. 1 is a schematic view of a system for providing depth-ranked content provision, in accordance with an embodiment;

FIG. 2 is a flowchart illustrating a process for providing depth-ranked content, in accordance with an embodiment;

FIG. 3 is a schematic view of a graphical user interface that provides depth-ranked content, in accordance with an embodiment;

FIGS. 4 and 5 are schematic views of depth-ranked content organized in a graphical user interface using various three dimensional shapes;

FIG. 6 is a schematic diagram of multi-position depth-ranked content provision, in accordance with an embodiment;

FIG. 7 is a schematic diagram of depth-ranked content provision based upon metadata, in accordance with an embodiment;

FIG. 8 is a schematic diagram of depth-ranked stock content provision, in accordance with an embodiment;

FIG. 9 is a schematic diagram of depth-ranked movie content provision, in accordance with an embodiment;

FIG. 10 is a schematic diagram of depth-ranked content organized according to external factors, in accordance with an embodiment;

FIG. 11 is a schematic diagram illustrating depth-ranked provision of content via a head-up display, in accordance with an embodiment;

FIG. 12 is a schematic diagram illustrating depth-ranked provision of content via a primary display, where camera prospective may be changed to provide a varied view of the depth-ranked provision, in accordance with an embodiment;

FIG. 13 is a schematic diagram illustrating depth-ranked provision of content via a virtual reality headset, where camera prospective may be changed via actuation of the headset, in accordance with an embodiment;

FIG. 14 is a schematic diagram illustrating zoom modification to depth-ranked provision of content, in accordance with an embodiment; and

FIG. 15 is a schematic diagram illustrating zoom modification of stock-based data depth-provision, in accordance with an embodiment.

### DETAILED DESCRIPTION

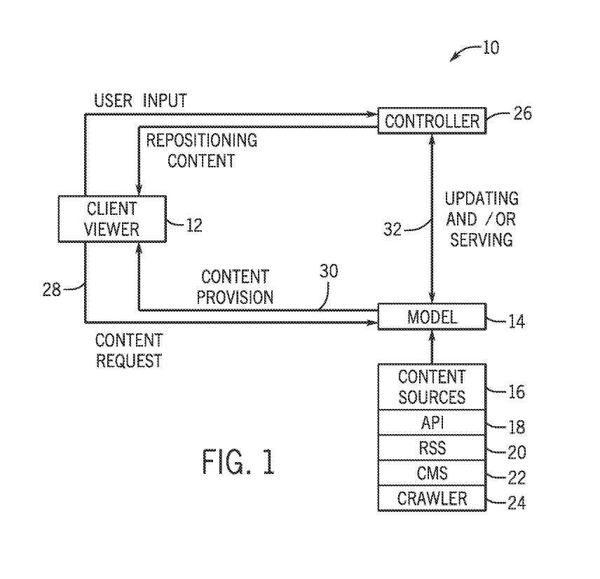

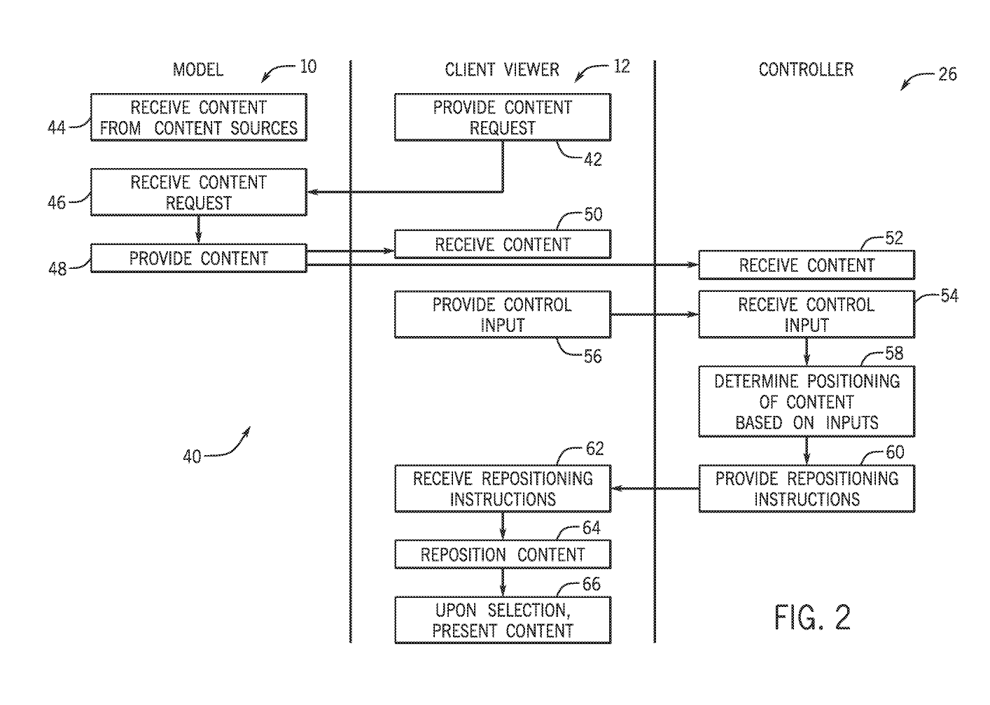

As previously mentioned, users oftentimes wish to be passively offered to content for consumption. FIG. 1 is a schematic view of a system 10 for providing depth-ranked content provision, in accordance with an embodiment. FIG. 2 is a flowchart illustrating a more detailed process 40 for providing depth-ranked content, in accordance with an embodiment. For clarity, FIGS. 1 and 2 will be discussed together.

The system 10 includes a client viewer 12 where content is passively presented to a content consumer. Further, a model component 14 be included in the system 10 that compiles passive content from one or more content sources 16. For example, content sources 16 may include data provided by an application programming interface (API) 18, a rich site summary (RSS) feed 20, a content management system (CMS) feed 22, and/or web crawler content 24. Other content sources 16 may also be used. For example, transferred data files (e.g., comma-separated value files, XML, etc.) may be retrieved by the model 14. The content may include web links, video, audio, emails, and/or other data (e.g., stock quotes, news stories, etc.).

The system 10 may also include a controller 26 that is in charge ordering a presentation of content at the viewer 12 based upon a ranking of content compiled by the model component 14. For example, an interest ranking or other ranking factor may be used to determine a ranking of at least a portion of the data received by the content sources 16. This ranking may occur at the model component 14 or the controller component 26. As will be discussed in more detail below, the controller 26 may control presentation of the passive content at the client viewer 12. For example, the controller 26 may present a depth-based (e.g., Z-access variable) representation of the content at the client viewer 12 based upon the ranking.

As indicated by communications arrow 28, in certain embodiments, the client viewer 12 may provide a request for content to the model module 14 (block 42). The request may be an explicit indication of particular data to be received (e.g., subscription to a stream of content) and/or may be a less-explicit indication of data to be received (e.g., an indication of previously viewed content that is used to request related content).

In parallel and/or subsequent to provision of the content request, the model module 14 may acquire content from the one or more content sources 16 (block 44). Upon receiving the content request (block 46), the model module 14 provides content (or an indication of the content) to the client viewer 12 and/or the controller 26, as indicated by the communications arrows 30 and 32 of FIG. 1, respectively (block 48).

The content is received by the client viewer 12 (block 50) and may optionally be presented at the viewer 12 prior to adding ranked-based depth to the view (not shown). For example, the content (or an indication of the content) may be provided in a flat view until the content is ranked and a depth-based view is generated.

In the current embodiment, the ranking occurs in the controller 26. In alternative embodiments, the ranking may occur in the model module 14 and/or the client viewer 12. To rank the content, the controller 26 receives the content (block 52). Additionally, the controller 26 may receive control inputs (block 54) provided by the client viewer 12 (block 56). The control inputs provide one or more variables that determine placement of the content (or an indication of the content) on the client viewer 12. For example, the control inputs might include interests or other preferences of a user of the client viewer 12. In some embodiments, environmental variables, such as screen placement, etc. may be provided as a control input, such that placement of the content may be affected by these environmental variables.

Based upon the received control inputs, preferred positioning (e.g., X-axis and/or Y-axis coordinates when using Cartesian coordinates) and depth presentation (Z-axis when using Cartesian coordinates) of the content (or an indication of the content) is discerned (block 58). Based upon the preferred positioning, in some embodiments, the controller 26 provides re-positioning instructions to the client viewer 12 (block 60). Alternatively, the controller 26 may provide the ranking, such that the client viewer 12 may reposition the content using its own computer-implemented instructions.

Any number of coordinate systems may be used in positioning the content. For example, as discussed above, Cartesian coordinates may be used. Alternatively and/or additionally cylindrical coordinate systems, spherical coordinate systems, global-positioning system coordinates, etc. may be used to position and provide depth to the content.

In embodiments where the controller 26 provides re-positioning instructions, the client viewer 12 receives the repositioning instructions (block 62) and the content (or an indication of the content) is repositioned according to the repositioning instructions (block 64). In embodiments where an indication of the content is provided, the content viewer may discern the selection of the indication, and present the actual content upon such selection (block 66).

By using the process 40, the system 10 may present depth-ranked content via the client viewer 12. This may enable passive provision of content that is sorted in meaningful ways using three-dimensional spacing, which will be described in more detail below.

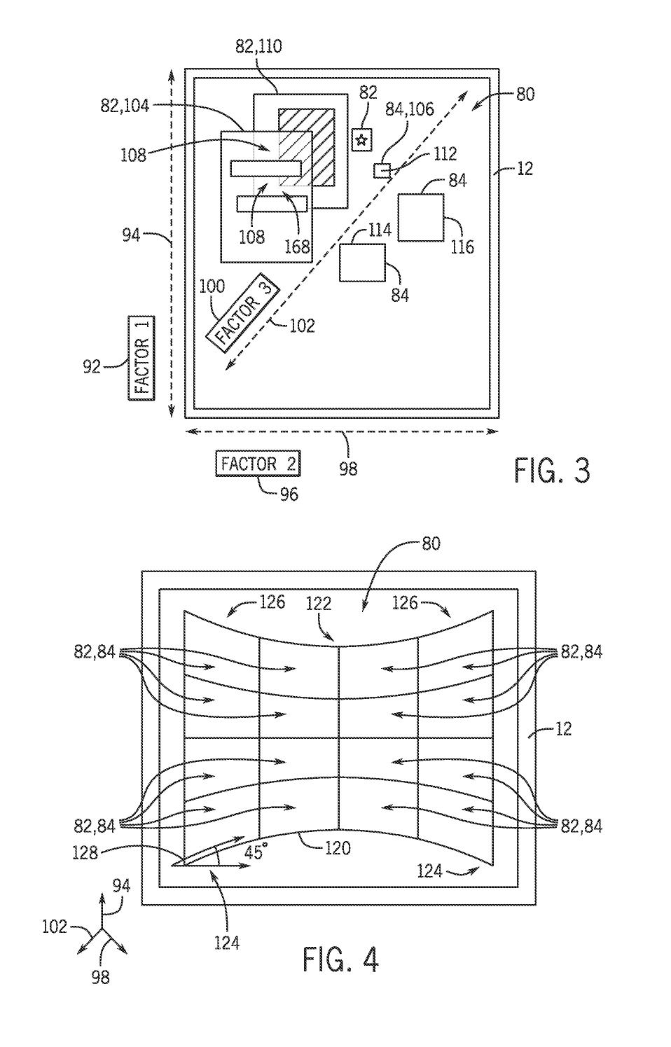

Turning now to a discussion of the actual depth-ranked view of the client viewer 12, FIG. 3 is a schematic view of a graphical user interface (GUI) 80 that provides passive depth-ranked content, in accordance with an embodiment. The GUI 80 may provide a variety of content 82 (e.g., video, images, text, etc.) that may be of interest to a user of the client viewer 12. In some embodiments, the GUI 80 may additionally or alternatively provide an indication 84 of content, such as content card that provides an indication that content is accessible. In some embodiments, the content 82 and/or the indication of content 84 (e.g. the content cards) may pertain to news, sports, technology, and/or stock information.

In the embodiment of FIG. 3, a first factor 92 may be used to position content (or an indication of content) in the Y-axis 94 of the GUI 80. A second factor 96 may be used to position content in the X-axis 98. A third factor 100 may be used to provide a depth placement (e.g., logarithmically scaled Z-axis 102 positioning) of the content (or the indication of the content). For example, as will be discussed in more detail below, metadata may be used to position content 82 or the indication of content 84 in the X-axis 98 and Y-axis 94. Further, depth placement may be particularly useful to provide a prioritization and/or ranking of content 82 and/or content indications 84, because the content 82 and/or content indications 84 may appear closer or farther from the user based upon this positioning. As a perspective of content 82 and/or content indications 84 cause the content 82 and/or indications 84 to appear closer to the front of the viewer 12, the content 82 and/or content indications 84 may appear to “pop out” towards the user, thus grasping more attention from the user. As the perspective of the content 82 and/or indications 84 cause the content 82 and/or content indications 84 to appear distant, the content 82 and/or indications 84 may grasp less attention of the user. Thus, by drawing a user's attention to content higher priority content, depth-ranking may be quite useful in presenting content 82 and/or content indications 84 in a more effective manner than traditional passive content provision mechanisms.

Sizing, coloring, parallax, and/or transparency variations of the content 82 and/or content indications 84 may be used to present varied depth (e.g., Z-axis 102 placement) of the content 82 and/or content indications 84. Further, speed, velocity, and/or direction may also be used to present a varied depth.

In the embodiment of FIG. 3, the highest priority content and/or content indication 104 has the largest size, making it appear to be closer than the other content 82 and/or content indications 84. Further, the lowest priority content and/or content indication 106 may have the smallest sizing. In some embodiments, transparency features may be used to illustrate content 82 and/or content indications 84 that are at different Z-axis 102 placements. For example, transparency zone 108 may provide an indication that content 110 is at a lower Z-axis 102 coordinate than the highest priority content 104, by indicating that content 104 overlaps content 110. Additionally, in some embodiments, coloring may be used to provide an indication of varied Z-axis 102 positioning. For example, the lowest priority content and/or content indications may include heavier shading features 112 than the highest priority content 82, providing a visual appearance that the lowest priority content 106 is farther away than the highest priority content 82.

For simplicity, the above discussion regarding sizing, coloring, and transparency variations separates content 82 and/or content indications 84 having the highest priority (e.g., highest priority content and/or content indications 104) and content 82 and/or content indications 84 having the lowest priority (e.g., lowest priority content and/or content indications 112). It is important to note that while the relationship between the highest and lowest prioritized content 82 and/or content indications 84 is discussed below, any number of intermediate levels of prioritized content 82 and/or content indications 84 (e.g., intermediate level content 114, 116, and 110) may exist between the highest and lowest levels of prioritization. The content 82 and/or content indications 84 in each of these intermediate priority levels may have a respective amount of variation in sizing, color, and/or transparency variation.

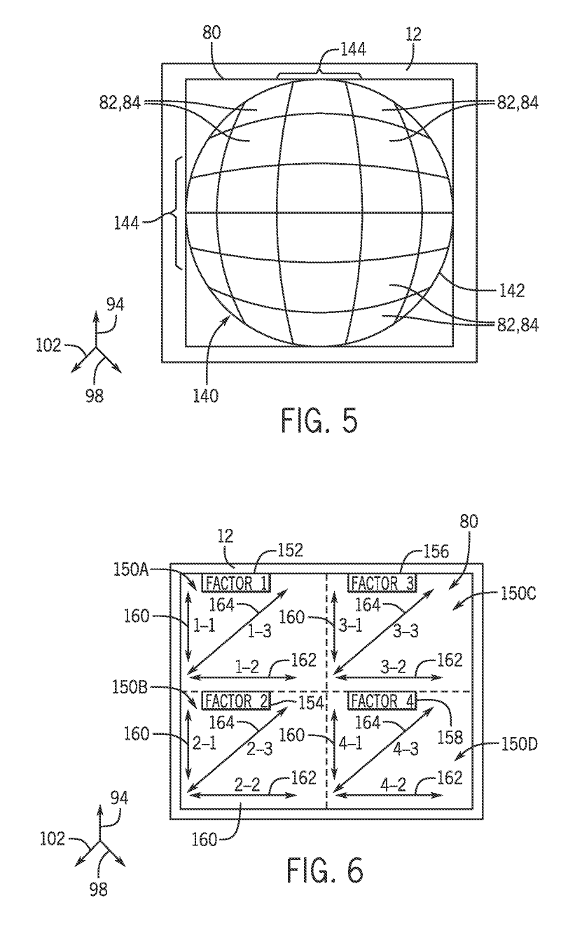

FIGS. 4 and 5 are schematic views of depth-ranked content organized in the graphical user interface (GUI) 80 of the client viewer 12 that uses varied three dimensional shapes to provide depth-ranked views of passive content. For example, FIG. 4 illustrates a three-dimensional ribbon 120 with a recessed central region 122 and protruding ends 124. In some embodiments, the three-dimensional ribbon 120 may be used to provide an immersive and/or surround-view presentations (e.g., spherical, hemispherical, and/or 360 degree band presentation), such that a user may appear surrounded by depth-ranked content. For example, the three-dimensional ribbon 120 may be presented in a manner that appears to wrap around the camera perspective.

In some embodiments, a three-dimensional coordinate system may be used to position content in a three-dimensional shape, such as the three-dimensional ribbon 120. For example, when the three-dimension ribbon 120 forms a cylinder (or one or more cylindrical portions), the cylindrical coordinate system may be used for content positioning. When spherical three-dimensional shapes are used, spherical coordinate systems may be used to position content, etc. Further, as will be discussed in more detail below, camera perspective may change based upon one or more factors (e.g., user input, etc.). Thus, positioning may be based upon relational camera perspectives.

In some embodiments, it may be desirable to present content 82 and/or content indication 84 rankings in a manner that is not solely based upon depth (e.g., Z-axis position). For example, in the embodiment of FIG. 3, increased ranking causes increased Z-axis positioning. However, in the embodiment, of FIG. 4, it may be more desirable to provide highly-ranked content 82 and/or content indications 84 towards the center of the ribbon 120, despite the ribbon 120 having a recessed central region 122.

As mentioned above, the goal of the depth-ranked presentation in the GUI 80 is to draw the user's attention to the content 82 and/or content indications 84 having a higher priority or ranking, while still presenting the lower prioritization or ranked content 82 and/or content indications 84. The design of the ribbon 120 results in content 82 and/or content indications 84 appearing more perpendicular to the client viewer 12. For example, the content 82 and/or content indications 84 in columns 126 appear more perpendicular than content and/or content indications 84 in the recessed central region 122. Accordingly, it may be more effective to present highly-ranked content in the recessed central region 122 than near the protruding ends 124.

In some embodiments, a maximum degree of perpendicular appearance may determine where to place the ranked content in particular shapes. For example, if the shapes result in a relatively low degree of perpendicular appearance (e.g., 60 degrees, 45 degrees, or lower), the ranking position may be based solely on correlated Z-axis 102 positioning (e.g., the higher the ranking, the higher the Z-axis 102 positioning). However, if the maximum degree of perpendicular appearance is large, a different positioning approach may be implemented (e.g., place the highest ranked content 82 and/or content indications 84 in the areas having the least degree of perpendicular appearance.

For example, in the embodiment of FIG. 4, the maximum degree of perpendicular appearance 128 within the shape (e.g., ribbon 120) is at the edges 124, which may be approximately 45 degrees, which may be relatively low. Accordingly, content 82 and/or content indications 84 at the edges 124 may still be easily viewed, despite appearing slightly perpendicular. Accordingly, the content 82 and/or indication 84 placement may be based upon correlating rankings with Z-axis 102 positioning (e.g., the higher the ranking the higher the Z-axis 102 positioning). Accordingly, the highest ranked content 92 and/or indications would appear near the edges 124.

If the maximum degree of perpendicular appearance 128 was significant (e.g., 60 degrees or higher), the placement method may vary. For example, the highest ranked content may be positioned near the areas having the least amount of perpendicular appearance (e.g., the “flattest” appearance) first and then based upon Z-axis positioning. Thus, the highest priority content 82 and/or indications 84 would appear near the recessed central region 122. If the ribbon 120 had a protruding region in addition to the recessed central region 122, content 82 and/or content indications 84 could be placed first in the flat parts of the protrusion and then the flat parts of the recessed central region 122, resulting in the less prioritized content 82 and/or content indications 84 being placed in the less flat regions leading to the protruded and recessed areas.

FIG. 5 illustrates content 82 and/or content indications 84 organized in a three-dimensional sphere 140. In the sphere 140, the content 82 and/or content indications 84 near the circumference 142 of the sphere 140 appear to be almost perpendicular (e.g., 90 degrees from the client viewer 12). The sphere 140 includes a front face and a rear face. Because the front face of the sphere 140 is more likely to grasp the attention of a user, the front face may be populated with the highest ranked content 82 and/or content indications 84. The placement may continue around the sphere 140 in north, south, east, and west directions, placing the next highest priority content 82 and/or indications 84 towards the center strips 144 of the north, south, east, and west directions. Accordingly, if a user rotates the sphere 140 directly in north, south, east, and/or west directions, prioritized content 82 and/or indications 84 may be presented in the highest Z-axis 102 position of the rotated sphere 140.

In some embodiments, a multitude of factors and sub-factors may be used to determine the positioning and depth of content 82 and/or indications 84. FIG. 6 is a schematic diagram of the GUI 80 including multi-position depth-ranked content provision, in accordance with an embodiment. As previously mentioned, the X-axis 98 and the Y-axis 94 may be used to position the content 82 and/or the indications 84. In some embodiments, the X-axis 98 and Y-axis 94 coordinates may be used to create multiple regions 150 of the GUI 80, where content 82 and/or indications 84 may be placed according to corresponding factors. For example, in the current embodiment, GUI 80 is divided into quadrants. Each quadrant holds content 82 and/or content indications 84 associated with a corresponding factor. The upper-left quadrant 150A holds content 82 and/or indications 84 associated with a first factor 152. The lower-left quadrant 150B holds content 82 and/or indications 84 associated with a second factor 154. The upper-right quadrant 150C holds content 82 and/or indications 84 associated with a third factor 156. The lower-right quadrant 150D holds content 82 and/or indications 84 associated with a fourth factor 158.

The factors 152, 154, 156, and 158 may relate to any characteristic of the content 82 and/or the content indications 84. For example, the factors 152, 154, 156, and 158 may organize the content 82 and/or content indications 84 based upon particular topics associated with the content 82 and/or indications 84. The granularity of these topics may be modified based upon a desired granularity of organization of the content 82 and/or indications 84. For example, for less granular organization, broad topics of the content 82 and/or content indications 84 may be used, such as: News, Sports, Technology, and/or Stocks. When more granular organization is desired, narrower topic categories may be used, such as U.S. News, College Sports, New Inventions, and/or International Stocks.

Because the GUI 80 is divided into regions 150, sub-x-axis 160 and sub-y-axis 162 in each region 150 may be used to further organize the content 82 and/or content indications 84. Further, a sub-z-axis 164 in each region 150 may provide a depth-ranking. For example, if the first factor 152 relates to sports, the sub-x-axis 160 in region 150A could relate to particular levels of sports ranging from Little League to national level sports. Further, the sub-y-axis 162 could relate to particular sports ranging from swimming to football. Thus, when content 82 and/or indications 84 relating to sports are received, they may be organized in the region 150A based upon sporting level (e.g., Little League sports at the vertical bottom, collegiate sports in the vertical middle, and national level sports at the vertical top). Further, the content 82 and/or indications 84 may be organized horizontally based upon a type of sport (e.g., swimming at the horizontal left, tennis at the horizontal middle, and football at the horizontal right). This granular organization may occur for each of the regions 150. Additionally, the regions 150 may include separate rankings, which may be presented according to corresponding sub-z-axis in each of the regions 150.

Further, an additional level of organization may be obtained based upon a ranking of the content 82 and/or indication 84. In one embodiment, the ranking may be based upon a predicted interest of the user in the available content 82 and/or indications 84. For example, if the user of the content viewer 12 typically enjoys reading about a first set of players and dislikes reading about a second set of players, content 82 and/or indications 84 pertaining to the first set of players may be ranked highly and content 82 and/or indications 84 pertaining to the second set of players may be ranked lowly. Content 82 and/or indications 84 not pertaining to either the first set of players or the second set of players may receive an intermediate ranking.

The calculation of the ranking may be based upon any number of factors. For example, a user may provide user inputs indicating one or more preferences regarding content 82 and/or content indications 84. In one example, the user inputs may be provided based upon a survey provided to the user via the client viewer 12.

Additionally, preference information may be obtained by monitoring activities of the user. For example, a user's interaction with a website, social media site, etc. may indicate preferences of the user. For example, if the user is on a social network site and “likes” particular content 82 and/or content indications 84 or particular topics/information that may be associated with content 82 and/or content indications 84, inferences regarding the user's preferences may be made. These inferences may be provided to the controller 26 (of FIG. 1) to be used in ranking calculations. Further, when a user selects content 82 and/or content indications 84 in GUI 80, the system may learn particular subject matter interests based upon the selected content 82 and/or content indications 84. For example, if the user selects a comedy clip involving a dog, the system may infer that the user enjoys dogs, comedies, or both. If the user then browses a website relating to pets, the system may more confidently infer that the user enjoys dogs. Based upon this information, dog-related content 82 and/or content indications 84 may receive a preferred ranking.

In some embodiments, specialty content and/or content indications may receive a ranking that trumps all other content and/or content indication rankings. This trump ranking may, in some embodiments, require a user to acknowledge the content, before other content and/or indications may be selected. This may be useful, for example, when content is provided from the Emergency Alert System (EAS), such as AMBER alerts and/or targeted weather alerts. By providing a trump ranking, the system may insure that emergency-related content (or other desired content) receives increasingly prompt attention.

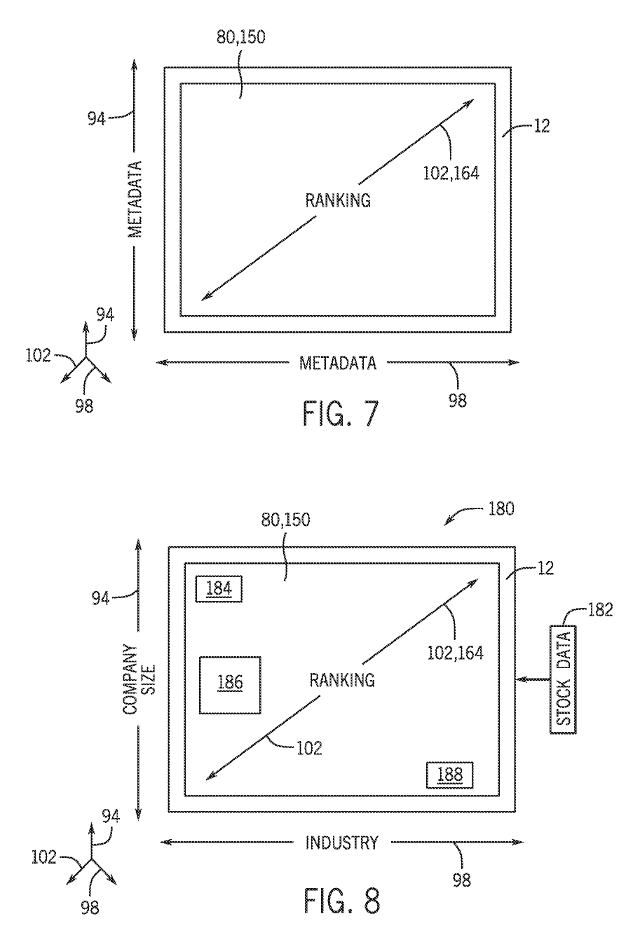

Turning now to particular use cases for depth-ranked provision of content, FIG. 7 is a schematic diagram of depth-ranked content provision based upon metadata, in accordance with an embodiment. As mentioned previously, any metadata that is associated with the content 82 and/or content indications 84 may be used in the placement of the content 82 and/or content indications 84 within the GUI 80 and/or GUI regions 150. For example, using email as an example, the received data, author of the email, intended recipient of the email, subject, etc. may be used in the positioning of email notifications within the GUI 80 and/or the GUI regions 150. Additionally, the ranking of the content 82 and/or content indications 84 may be presented using the Z-axis 102 of the GUI 80 and/or the z-sub-axis 164 of the GUI region 150.

FIG. 8 provides a stock content context 180 of depth-ranked stock content provision, in accordance with an embodiment. As mentioned above, any metadata may be used to organize the content 82 and/or content indications 84 within the GUI 80 and/or GUI regions 150. In the current embodiment, stock information 182 (e.g., stock prices, etc.) is received at the client viewer 12. The GUI 80 and/or GUI regions 150 may organize the received data 182 based upon a size of the company associated with the stock data and/or an industry of the company associated with the stock data. Accordingly, stock information 184 relating to a large-cap energy company may be presented in the top left, stock information 186 relating to a mid-cap energy company may be presented in the middle-left, and stock information 188 relating to a small-cap food company may be presented in the lower-right.

The ranking of any content 82 and/or content indication 84 may be based upon inferred and/or specified user preferences. For example, a user may identify a particular preference to receive data relating to company associated with stock information 186. Further, the system 10 may notice that the user does not typically look at food related stock information.

Thus, the system 10 may discern that stock information 186 should have the highest ranking/priority and stock information 188 should have the lowest ranking/priority (e.g., because the user has identified a particular preference to receive data relating to company associated with stock information 186 and the user does not typically look at food related stock information).

Alternatively, the ranking of content 82 and/or content indications 84 may be based upon factors independent of user preference. The stock data 182 may be depth-ranked based upon metadata of the stock data 182, such as a magnitude of trading volume, Internet chatter (e.g., social media postings, increased news postings, etc.) relating to the particular stock symbols, a magnitude of value change related to the stock information, etc. Alternatively, the ranking may be based upon observed stock patterns/trends.

For example, perhaps there has been a large trade volume or Internet buzz surrounding the company associated with stock information 186 and very little trading of the stock associated with stock data 188. The system 10 may discern that stock information 186 should have the highest ranking/priority and stock information 188 should have the lowest ranking/priority based upon these factors.

In either case, the size of the stock information 186 would be presented closer (e.g., larger, lighter, etc.) than stock information 184 and stock information 188. Further stock information 188 would be presented farther away (e.g., smaller, darker, etc.) than stock information 184.

As mentioned above, particular attributes of the content 82 and/or content indications 84 may be applied, indicating additional information regarding the content 82 and/or content indications 84. For example, with stock information 182, particular stocks may increase and/or decrease throughout the day. A color attribute may be associated with the presentation of the stock information, in order to indicate whether a particular stock is increasing or decreasing in value. For example, if stock information 186 is increasing in value, it may be presented in green. If the stock information 184 is decreasing in value, it may be presented in red. If stock information 188 is unchanged, a default color (e.g., white or gray) may be associated with the stock information 188.

In some embodiments, the content 82 and/or content indications 84 may at least partially overlap. For example, the received stock information 182 may include multiple mid-cap energy stocks. The system may position this content 82 and/or content indications 84 in a manner where they at least partially overlap, but still remain visible to the user, as was illustrated with regard to the content 104 and 110 in FIG. 3.

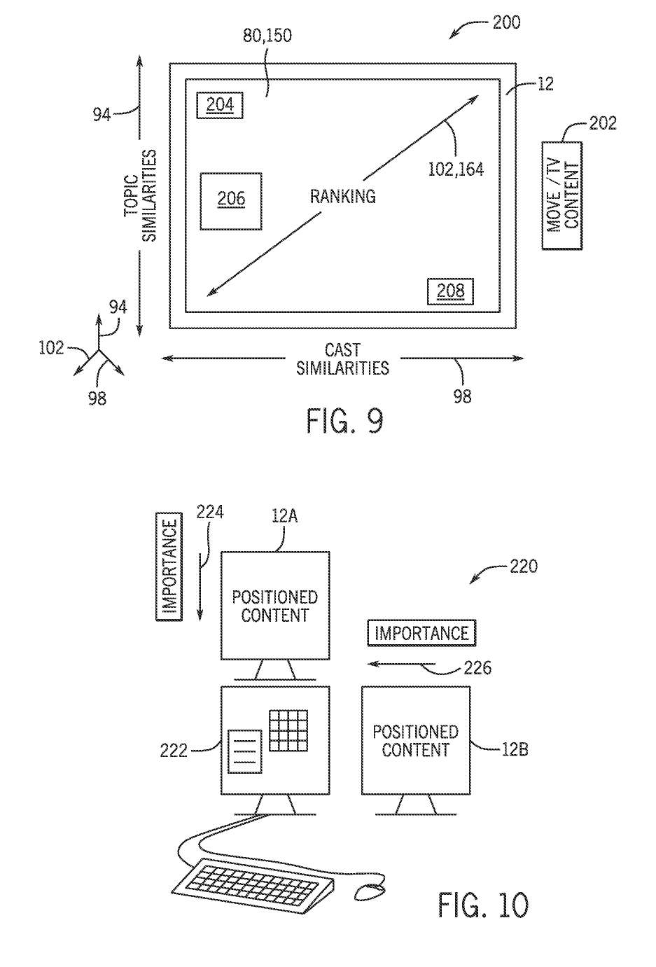

FIG. 9 provides a movie and/or television show context 200 of depth-ranked movie content provision, in accordance with an embodiment. In the current embodiment, movie and/or television content 202 (e.g., a trailer, an actual movie video file, a movie clip, etc.) is received at the client viewer 12. Any metadata relating to the movie and/or television content 202 may be used to organize the content and/or content indications. For example, in the current embodiment, the GUI 80 and/or GUI regions 150 may organize the received data 202 based upon a topic associated with the movie and/or television content 202 and/or a cast associated with the movie and/or television content 202. Accordingly, movie and/or television content 204 relating to comedies staring Steve Carell may be presented in the top left. Movie and/or television content 206 relating to a dramas staring Steve Carell may be presented in the middle-left. Additionally, movie and/or television content 208 relating to documentaries staring actors other than Steve Carell may be presented in the lower-right.

The ranking of any content 82 and/or content indication 84 may be based upon inferred and/or specified user preferences. For example, a user of the system 10 may indicate a particular preference to receive data relating to Steve Carell. Further, the system 10 may observer that the user typically watches dramas and, thus, infer that the user enjoys dramas.

Based upon this information, the system 10 may discern that movie and/or television content 206 should have the highest priority (e.g., because the user has identified a particular preference to receive data relating to Steve Carell and also enjoys dramas) and movie and/or television content 208 should have the lowest priority (e.g., because the user does not typically appear interested in documentaries).

Alternatively, the ranking of content 82 and/or content indications 84 may be based upon factors independent of user preference. The movie and/or television content 206 may be depth-ranked based upon metadata of the movie and/or television content 206, such as a release data, Internet buzz, and critic reviews, etc.

For example, perhaps content 206 is a new release or there is significant Internet buzz surrounding content 206. Further, there may be very little Internet buzz regarding content 208 or content 208 may have been release a year ago. The system 10 may discern that content 206 should have the highest ranking/priority and content 208 should have the lowest ranking/priority based upon these factors.

In either case, the size of the movie and/or television content 206 are larger than movie and/or television content 204 and movie and/or television content 208. Further movie and/or television content 208 are smaller than movie and/or television content 204. Thus, the GUI 80 and/or the GUI region 150 provides an appearance that movie and/or television content 206 is closer and movie and/or television content 208 is farther away, drawing the user's attention to movie and/or television content 206.

External factors may also play a role in organizing the content 82 and/or content indications 84. FIG. 10 is a schematic diagram of system 220 providing depth-ranked content organized according to external factors that are independent of metadata of the content 82 and/or content indications 84, in accordance with an embodiment.

In the embodiment of FIG. 10, two client viewers 12A and 12B are present. Client viewer 12 A is positioned above a primary work monitor 222 which typically occupies a user's focus. The client viewer 12B is positioned to the right of the primary work monitor 222. The position of the client viewer 12A and 12B relative to the primary work monitor 222 may be used to capture a user's attention. For example, the client viewers 12A and 12B may attempt to make use of the user's peripheral vision, by placing important and/or interesting content 82 and/or content indications 84 closer to the primary work monitor 222. Accordingly, as the user is focused on the primary work monitor 222, important and/or interesting content 82 and/or content indications 84 may be presented in the user's peripheral vision. Upon observing this content, the user may focus one or more of the content viewers 12A and/or 12B.

For example, as illustrated by arrow 224, client viewer 12A may position important and/or interesting content in a region closest to the primary work monitor 222 (e.g., towards the bottom of client viewer 12A). Further, client viewer 12B may also position important and/or interesting content in a region closest to the primary work monitor 222 (e.g., towards the left of the client viewer 12B). Similar repositioning may occur when the client viewer 12A and/or 12B is a sidebar within the primary work monitor 222. For example, in a system that only includes one monitor, but includes a client viewer as a top-bar, bottom-bar, or side-bar, the content 82 and/or content indications 84 that may be of most interest to the user may be position closest to the work area of the monitor.

Having now discussed the provision of depth-ranked content, the discussion now turns to systems that may provide the depth-ranked content and navigation in the depth-ranked content presentation.

Many different systems may provide depth-ranked content. For example, the depth-ranked content may be provided via a personal computer (e.g., in a sidebar or as the primary content of a graphical user interface (GUI) of a primary and/or supplemental monitor of the personal computer), a television, a mobile device (e.g., a smartphone, tablet computer, etc.), a head-up display (e.g., vehicular heads-up display, eyeglass display, or other transparent display system that presents data without requiring users to look away from their usual viewpoints), a three-dimensional viewer (e.g., a steroscoping 3-D display), or virtual reality environment (e.g., via a virtual reality headset, such as the Oculus Rift).

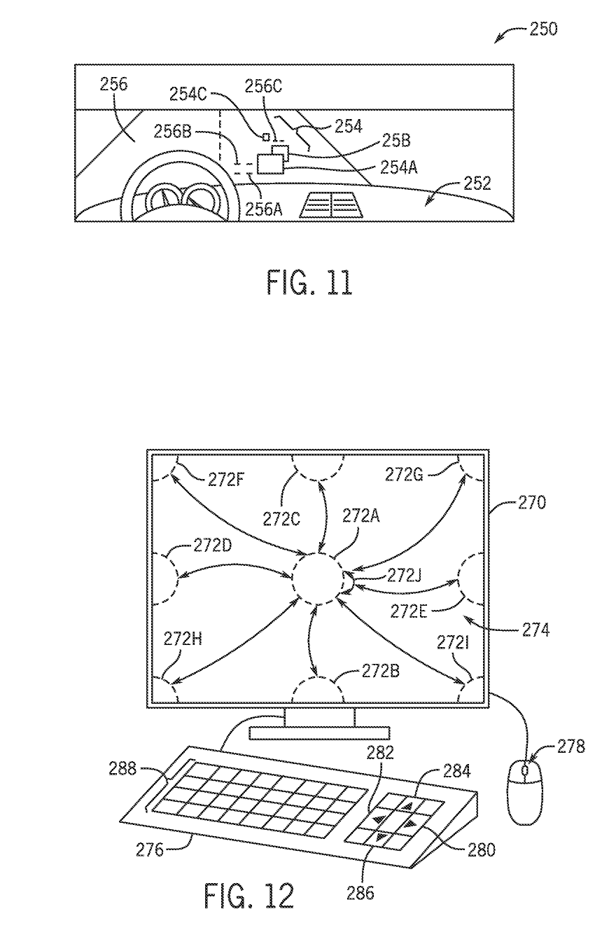

FIG. 11 is a schematic diagram illustrating depth-ranked provision of content via a head-up display (HUD) 250, in accordance with an embodiment. As illustrated, the HUD 250 is in a vehicle environment 252. In alternative embodiments, the HUD 250 may be in an eye-glass display or other transparent display system that presents data without requiring users to look away from their usual viewpoints. As discussed in FIG. 10, important content (e.g., content that the user may be more interested in or that a content provider wants to bring to the user's attention over other content) may be positioned closer to a user's focused vision, bringing that content into the user's peripheral vision. In vehicle environment 252 embodiments, the depth-ranked content 254 may relate to location-relevant content determined, for example, using a global positioning system (GPS) of the vehicle or a device in the vehicle.

In some embodiments, the content 254 may zoom forward at a rate based upon the speed of the vehicle. Thus, as the vehicle moves down the road, 256, content 254A may move out of visible range, resulting in content 254B becoming the content in the forefront of the HUD 250. Eventually, content 254C may become the primary content, as the vehicle moves further down the road 256. In some embodiments, the point in time at which content 254 not in the forefront becomes the forefront content may be determined based upon reaching particular distances. For example, in the current embodiment, content 254A may be presented (e.g., size and/or positioning) in a manner that indicates that content 254A may be available until location 256A is reached by the vehicle. Content 254B may be presented in a manner (e.g., size and/or positioning) that indicates it will be visible until distance 256B is reached. Content 254C may be presented (e.g., size and/or positioning) in a manner that indicates that content 254C is available until location 256C is reached. As may be appreciated, similar distance-based focusing may be used in any HUD system (e.g., an eye-glass system, etc.).

In some embodiments, it may be beneficial to allow a user to modify a perspective of the depth-ranked content provision. FIG. 12 is a schematic diagram illustrating depth-ranked provision of content via a primary display 270, where camera prospective 272 (e.g., 272A-J) may be changed to provide a varied view of the depth-ranked content provision 274, in accordance with an embodiment. The camera perspective 272 may default to a centralized view 272A. To modify the camera perspective 272A, an input device, such as a keyboard 276 and/or a mouse 278 may be used to modify the camera perspective 272. For example, a right arrow key 280 may be used to modify the camera perspective 272A to a camera perspective 272 E from the right. The left arrow key 282 may be used to modify the camera perspective 272 to camera perspective 272D from the left. Up arrow key 284 and Down arrow key 286 may be used to change the perspective 272 to a camera perspective 272C from the top and camera perspective 272B from the bottom. Using combinations of the inputs (e.g., keys 280-286), other perspectives (e.g., diagonal perspectives 272F-I, backward perspective 272J, or any perspective in between the perspectives 272A-J) may be presented. Other keys 288, the mouse 278, and/or other input devices may be used to modify the perspective 272. For example, click-and-drag movement on the mouse 278 may provide a perspective change.

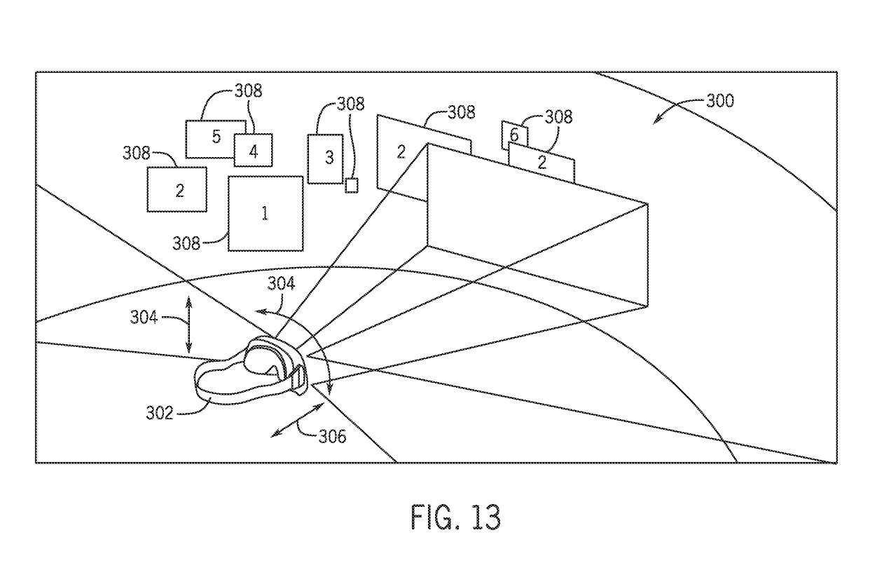

In some embodiments, the depth-ranked content presentation may be provided via a virtual reality environment. FIG. 13 is a schematic diagram illustrating depth-ranked provision of content via a virtual reality environment 300 using a virtual reality headset 302, where camera prospective 304 and/or zoom 306 may be changed via actuation (e.g., up/down and/or left/right movement) of the headset 302, in accordance with an embodiment. In some embodiments, zoom of depth-ranked content 308 may occur as a user moves forward in the virtual reality environment 300. Alternatively or additionally, zoom modification may occur based upon particular inputs (e.g., controller inputs, keyboard inputs, etc.) specifically dedicated to depth-ranked content 308 zoom.

Thus, as the user moves forward in the environment 300, the user may pass particular content 308, resulting in new content 308 being presented as the forefront content. As the user reverses movement the prior forefront content may re-enter view as the forefront content. Alternatively and/or additionally, the user may select a dedicated input, resulting in zoom modifications even when the user is not moving forward or in reverse in the environment 300.

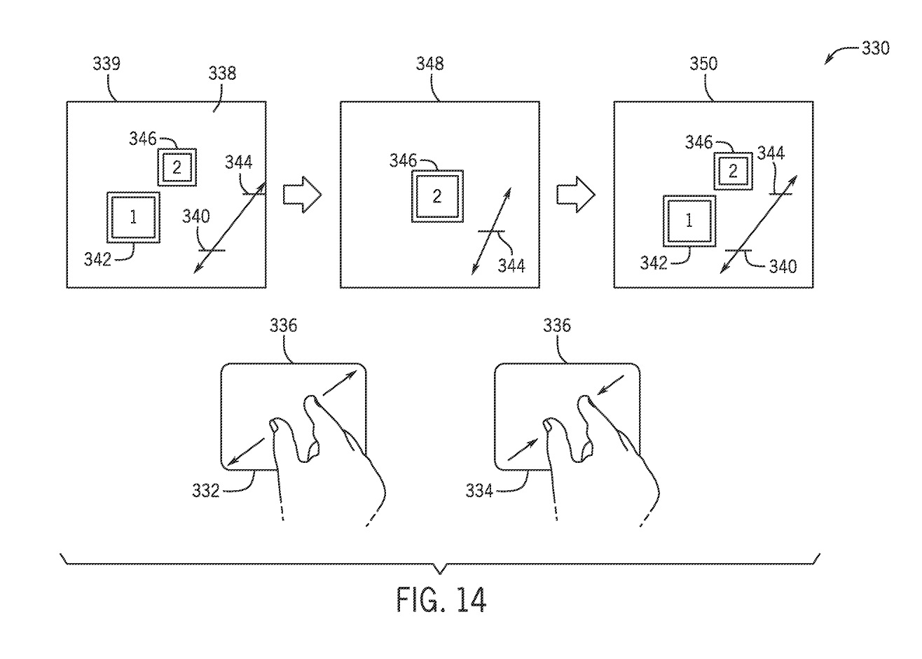

FIG. 14 is a schematic diagram illustrating gesture movements that may present a view modification in the depth-ranked viewer. For example, in FIG. 14, a progression 330 of zoom modifications to depth-ranked provision of content using stretching motions 332 and pinching motions 334 of a touch-device 336 (e.g., a touch-screen display, touch-pad, etc.), in accordance with an embodiment. As illustrated in display 338 (which, in some embodiments, may be the touch-device 336) at progression 339, a first level 340 of content 342 is presented at the forefront of the display 338. A second level 344 of content 346 is presented behind the level 340.

As a user provides a stretching motion 332, the presentation of the depth-ranked content may provide a forward zoom, eventually resulting in level 340 of content 342 moving out of the presentation and level 344 of content 346 becoming the forefront content (as illustrated in progression 348). When pinching motions 334 are provided, a reverse zoom may be provided in the depth-ranked content provision. Accordingly, level 340 may re-enter the presentation as the forefront content as illustrated in progression 350.

Any number of variations of gestures may be provided to modify characteristics of the depth-ranked content view. While FIG. 14 illustrates pinching and stretching, other gestures, such as head movement, arm movement, leg movement, eye movement, etc. may be used to control and/or modify characteristics of the depth-ranked content view.

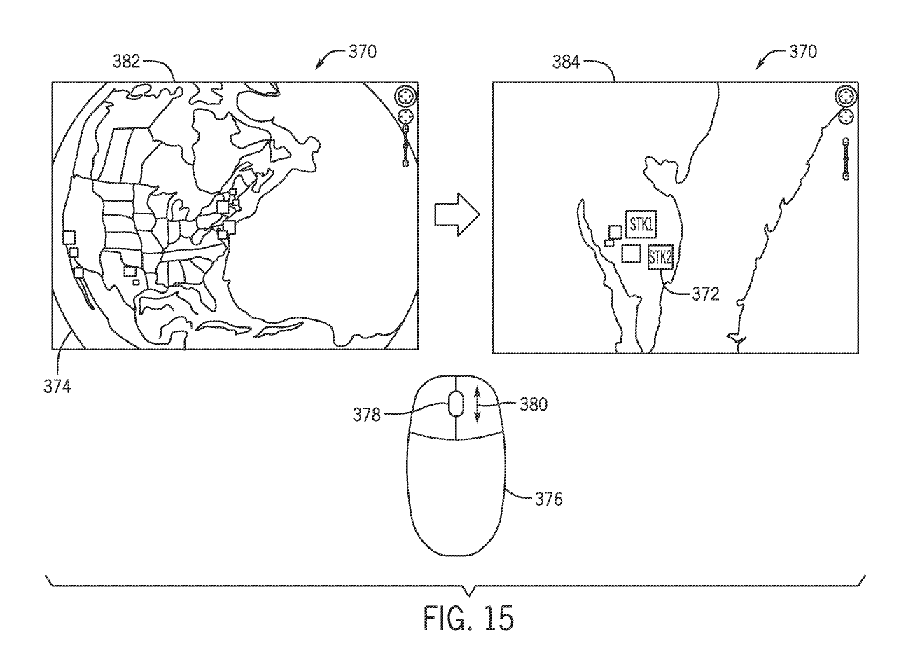

In one embodiment, stock data may be provided via a global view. FIG. 15 is a schematic diagram illustrating such a global view 370 where zoom modifications provide stock-based data 372 depth-provision, in accordance with an embodiment. In the embodiment of FIG. 15, the global view 370 provides the stock-based data 372 in positions distributed on the globe 374 based upon a location of incorporation of a business associated with the stock-based data 372). For example, stocks for New York based businesses are provided over New York on the globe 374. Further, companies with Delaware incorporation are positioned over Delaware. The stock-based data 372 with decreasing valuations may be presented in red, while stock-based data 372 with increasing valuations may be presented in green. The depth-ranking of the stock-based data 372 may be based upon any importance factor relating to stocks (e.g., particular stocks of interest for a user, trading volume, daily valuation change, etc.).

In the current embodiment, a scroll mouse 376 may be used to zoom in on particular areas of the globe 374 of interest. For example, the scroll wheel 378 may be moved 380 to zoom in and/or zoom out on the globe 374. For example, going from progression 382 to progression 384 illustrates zooming in on a particular area of interest of the globe 374. As the view is zoomed in, the detail of the depth-ranked content presentation may become clearer, by presenting the data in a larger presentation.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A computer-implemented method, comprising:
receiving a plurality of digital content, digital content indications, or both;
receiving computer-implemented instructions configured to position the plurality of digital content, digital content indications, or both;
presenting the plurality of digital content, digital content indications, or both with defined positioning that is dictated by the computer-implemented instructions;
wherein the defined positioning comprises a depth positioning that provides a varied depth appearance of the plurality of digital content, digital content indications, or both.

2. The computer-implemented method of claim 1, wherein the depth positioning is based upon a respective ranking of the plurality of digital content, digital content indications, or both.

3. The computer-implemented method of claim 1, wherein the defined positioning comprises rectangular coordinates, cylindrical coordinates, spherical coordinates, or a combination thereof, the rectangular coordinates, cylindrical coordinates, spherical coordinates, or combination thereof being based at least upon one or more factors.

4. The computer-implemented method of claim 3, wherein the one or more factors comprise factors related to metadata of the digital content, digital content indications, or both.

5. The computer-implemented method of claim 3, wherein the one or more factors comprise factors unrelated to metadata of the digital content, digital content indications, or both.

6. The computer-implemented method of claim 1, wherein the defined positioning comprises placement of the digital content, digital content indications, or both in a plurality of sub-regions based upon at least one factor.

7. The computer-implemented method of claim 1, wherein the defined positioning comprises placement of the digital content, digital content indications, or both in an organization that forms a three-dimensional shape.

8. The computer-implemented method of claim 7, wherein the three-dimensional shape comprises a sphere.

9. The computer-implemented method of claim 7, wherein the three-dimensional shape comprises a ribbon comprising protruding portions, recessed portions, or both.

10. The computer-implemented method of claim 1, wherein the digital content, digital content indications, or both comprises stock data and wherein the method comprises presenting the stock data in the defined position based upon industry information, company capitalization, or both.

11. The computer-implemented method of claim 10, wherein the depth positioning of the stock data is based upon an inferred user interest in the stock data, an explicit indication of interest in the stock data, valuation change data relating to the stock data, trade volume change data relating to the stock data, increased Internet discussion relating to the stock data, or any combination thereof.

12. The computer-implemented method of claim 1, wherein the digital content, digital content indications, or both comprises movie content, television content, or both and wherein the method comprises presenting the movie content, television content, or both in the defined position based upon a subject matter of the movie content, television content, or both, a genre of the movie content, television content, or both, casting of the movie content, television content, or both, or any combination thereof.

13. The computer-implemented method of claim 10, wherein the depth positioning of the movie content, television content, or both is based upon an inferred user interest in the movie content, television content, or both, an explicit indication of interest in the movie content, television content, or both, a release date of the movie content, television content, or both, review data relating to the movie content, television content, or both, increased Internet discussion relating to the movie content, television content, or both, or any combination thereof.

14. The computer-implemented method of claim 1, comprising:
receiving one or more camera modification inputs;
modifying a camera perspective, a camera zoom, or both of the presentation of the plurality of digital content, digital content indications, or both, based upon the one or more camera modification inputs.

15. The computer-implemented method of claim 14, comprising receiving the one or more camera modification inputs from a keyboard, a mouse, a virtual reality headset, a touch-screen, a touch-pad, or any combination thereof.

16. The computer-implemented method of claim 14, wherein the one or more camera modifications comprise a stretch motion input, a pinch motion input or both;
wherein the method comprises zooming forward when a stretch motion input is received and zooming outward when a pinch motion input is received.

17. A system, comprising:
a processor-based model module;
a processor-based controller; and
a processor-based client viewer;
wherein the processor-based model module is configured to:
obtain content, content indications, or both from one or more content sources; and
provide the content, content indications, or both to a processor-based controller and a processor-based client viewer;
wherein the processor-based controller is configured to:
determine a desired positioning of the content, content indications, or both based upon one or more factors; and
provide computer-implemented instructions to the processor-based client viewer, the computer-implemented instructions configured to instruct the processor-based client viewer to present the content, content indications, or both in the desired positioning, the desired positioning comprising a depth positioning that provides a varied depth appearance of the plurality of content, content indications, or both; and
wherein the processor-based client viewer is configured to:
receive the computer-implemented instructions; and
present the content, content indications, or both in accordance with the computer-implemented instructions.

18. The system of claim 17, comprising the content sources, wherein the content sources comprise an application programming interface data provider, a rich site summary feed, a content management system feed, web crawler data, or any combination thereof.

19. The system of claim 17, wherein the client viewer is configured to provide at least one user input to the controller, the user input affecting the desired positioning determined by the controller.

20. The system of claim 19, wherein the user input comprises a pattern of usage of the client viewer useful for interpreting a preference of the user, an explicit preference indication of the user, or both.

21. The system of claim 17, wherein the content viewer is configured to present the content, content indications, or both in a default order prior to receiving the computer-implemented instructions.

22. The system of claim 17, wherein the content viewer is configured to not present the content, content indications, or both prior to receiving the computer-implemented instructions.

23. The system of claim 17, wherein the client viewer comprises a virtual reality headset, wherein a camera perspective of the presentation of the content is varied when the virtual reality headset is moved left, right, up, down, or any combination thereof.

24. The system of claim 17, wherein the client viewer comprises a steroscoping three-dimensional display.

25. The system of claim 17, wherein the client viewer comprises a head-up-display.

26. The system of claim 25, wherein the head-up-display comprises a vehicle-based head-up-display, an eyeglass display, or both.

27. A processor-based device, configured to:
receive content, content indications, or both;
determine a desired positioning of the content, content indications, or both, the desired positioning comprising a depth positioning that provides a varied depth appearance of the content, content indications, or both;
provide machine-readable instructions to a client viewer, the machine-readable instructions configured to instruct the client viewer to present the content, content indications, or both in the desired positioning.

28. The processor-based device of claim 27, configured to rank or prioritize the content, content indications, or both based upon at least one factor.

29. The processor-based device of claim 27, wherein the at least one factor comprises an inferred user interest in the content, content indications, or both, an explicit interest in the content, content indications, or both, metadata of the content, content indications, or both, or any combination thereof.

30. The processor-based device of claim 27, configured to determine the varied depth appearance of the content, content indications or both by associating particular rectangular coordinates, cylindrical coordinates, spherical coordinates, or a combination thereof illustrating a closer depth to content, content indications or both that have a higher priority.

31. The processor-based device of claim 27, configured to determine the desired positioning, where the desired positioning organizes the content, content indications, or both in a particular three-dimensional shape having the varied depth appearance of the content, content indications or both.

32. The processor-based device of claim 31, configured to determine the desired positioning of the content, content indications, or both based upon a maximum degree of perpendicular appearance of the content, content indications, or both when organized in the particular three-dimensional shape.

33. The processor-based device of claim 32, configured to determine the desired positioning such that the content, content indications, or both that have a higher priority are in flatter portions of the particular three-dimensional shape when the maximum degree of perpendicular appearance is approximately 60 degrees or greater.

34. The processor-based device of claim 32, configured to determine the desired positioning such that the content, content indications, or both are positioned based upon priority, starting first with protruding flatter portions of the particular three-dimensional shape, then recessed flatter portions of the three-dimensional shape, then less flat portions of the three-dimensional shape.
